(19) United States
(12) Patent Application Publication
(10) Pub. No.: US 2007/0103558 A1
(43) Pub. Date: May 10, 2007

(54) Multi-view video delivery

(75) Inventors: Hua Cai, Beijing (CN); Jian-Guang Lou, Beijing (CN); Jiang Li, Beijing (CN)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/267,768

(22) Filed: Nov. 4, 2005

(51) Int. Cl. H04N 5/232; G06F 3/00; G06F 13/00; H04N 5/45; H04N 5/445

(52) U.S. Cl. 348/211.11; 725/37; 348/563; 348/564; 348/565

(57) ABSTRACT

The present example provides a system for delivering video streams with multi-view effects. Single-view video streams, each associated with a particular view, are provided by a server. A client may select to receive any of the single-view video streams. The server is further configured to generate a multi-view video stream from frames in the single-view video streams. The multi-view video stream may include visual effects and may be provided to the client to enhance the user experience. The visual effects may include frozen moment and view sweeping.

### BACKGROUND

A conventional single-view video stream typically includes frames captured using one video camera and encoded into a data stream, which can be stored or delivered in real-time. Multiple cameras may be used to capture video data from different views, such as views from different directions relative to the subject. The video data from different cameras may be edited to provide a video stream with shots from various views to provide an enhanced user experience. However, these enhanced videos require extensive and experienced editing and are not feasible for delivery the videos in real-time. Furthermore, users have essentially no control over the views of the videos that are received.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a system for delivering video streams with multi-view effects. Single-view video streams, each associated with a particular view, are provided by a server. A client may select to receive any of the single-view video streams. The server is further configured to generate a multi-view video stream from frames in the single-view video streams. The multi-view video stream may include visual effects and may be provided to the client to enhance the user experience. The visual effects may include frozen moment and view sweeping.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows an example multi-view video delivery system.

FIG. 2 shows example components of the video server shown in FIG. 1.

FIG. 3 shows example single-view video streams generated by a video delivery system.

FIG. 4 shows an example of a multi-view video stream associated with a frozen moment effect.

FIG. 5 shows an example of a multi-view video stream associated with a view sweeping effect.

FIG. 6 shows an example user interface for viewing multi-view videos.

FIG. 7 shows frames of an example frozen moment multi-view video stream.

FIG. 8 shows frames of an example view sweeping multi-view video stream.

FIG. 9 shows an example process for delivering multi-view video streams.

FIG. 10 shows an example process for generating a video stream with a multi-view effect.

FIG. 11 shows an exemplary computer device for implementing the described systems and methods.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a video delivery system for capturing and providing videos from different view directions, the system described is provided as an example and not a limitation. As those skilled in the art will appreciate, the present examples are suitable for application in a variety of different types of video delivery systems that are capable of delivering videos created from frames of multiple video streams.

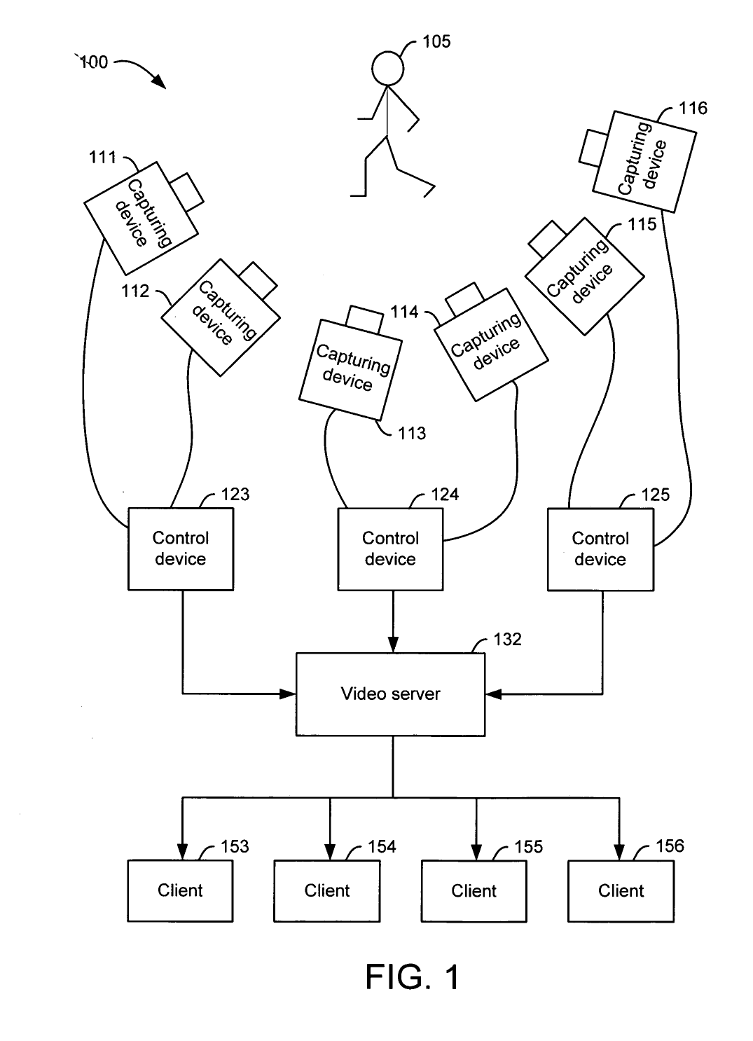

FIG. 1 shows an example multi-view video delivery system 100. As shown in FIG. 1, system 100 includes multiple capturing devices 111-116 that are configured to capture video data. In this example, each capturing device is configured to capture video data of subject 105 from a particular view direction that is different from the view directions associated with the other capturing devices. Thus, in the example implementation in FIG. 1, capturing devices 111-116 are configured to capture convergent views. Other implementations may provide different views, such as parallel views, divergent views, or the like. Capturing devices 111-116 may be configured to alter their positions and/or orientations. For example, capturing devices 111-116 may be configured to change their viewing directions relative to subject 105 in response to a command issued by a control device.

Control devices 123-125 are configured to control capturing devices 111-116 for video capturing. For example, control devices 123-125 may be configured to control the view directions of capturing devices 111-116. Control devices 123-125 may also be configured to handle video data generated by capturing devices 111-116. In an example implementation, control devices 123-125 are configured to encode video data from capturing devices 111-116 into video streams transmittable as digital video signals to another device, such as video server 132.

Video server 132 is configured to provide video streams to client 153-156. The video streams provided by video server 132 may be single-view video streams or multi-view video streams. A single-view video stream includes video frames of a single view direction associated with particular capturing device. A multi-view video streams contains video frames from multiple view directions. Typically, frames from a multi-view video stream include video data captured by multiple capturing devices. Single-view video streams may be encoded by one or more of the capturing devices 111-116, control devices 123-125, and video server 132. In one implementation, the single-view video streams are encoded by control devices 123-125, which provide the streams to video server 132 for delivery to clients 153-156. Video server 132 is configured to provide single-view and multi-view video streams to clients 123-125 in real-time or on demand. Video server 132 may be configured to enable clients 123-125 to select which video streams to receive.

The components of the example multi-view video delivery system 100 shown in FIG. 1 are shown for illustrative purposes. In actual implementation, more, less or different components may be used to achieve substantially the same functionalities. The illustrated components may be connected through any type of connections, such as wired, wireless, direct, network, or the like.

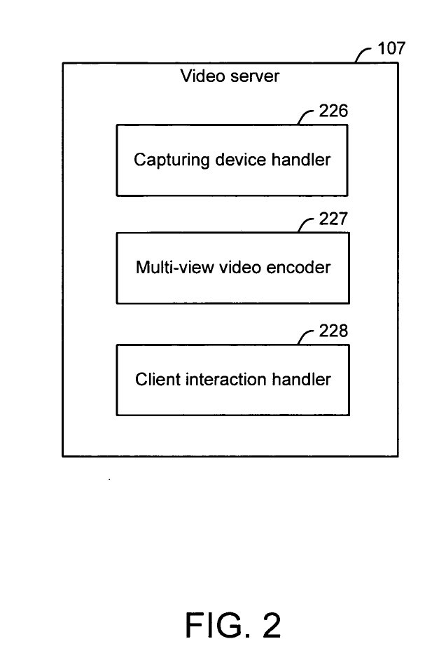

FIG. 2 shows example components of the video server 132 shown in FIG. 1. As shown in FIG. 2, video server 132 may include capturing device handler 226, multi-view video encoder 227, and client interaction handler 228. Capturing device handler 226 is configured to receive video data from capturing devices 111-116. The video data may be encoded as video streams and provided by control devices 123-125. Capturing device handler 226 may be configured to control various operating parameters of capturing devices 111-116 through control devices 123-125. These operating parameters may include position, orientation, focus, aperture, frame rates, resolution, and the like. Capturing device handler 226 may also be configured to determine information about single-view video streams provided by capturing devices 111-116. For example, this information may include the view direction associated each video stream, the timing of the frames in the streams relative to one another, operating parameters of the capturing device associated with each video stream, and the like.

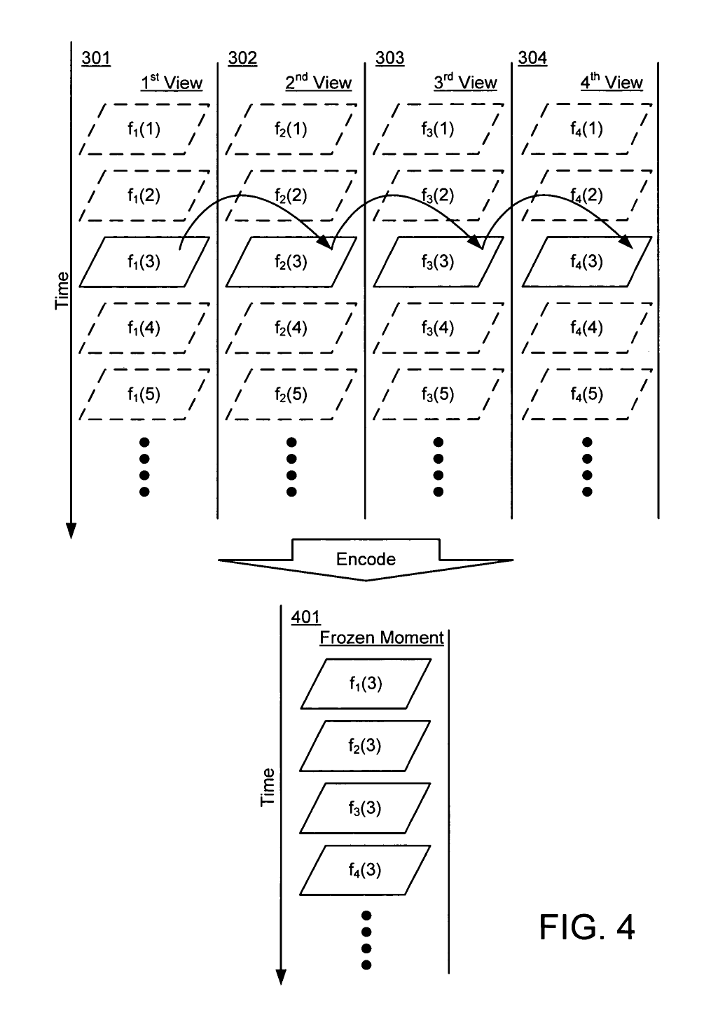

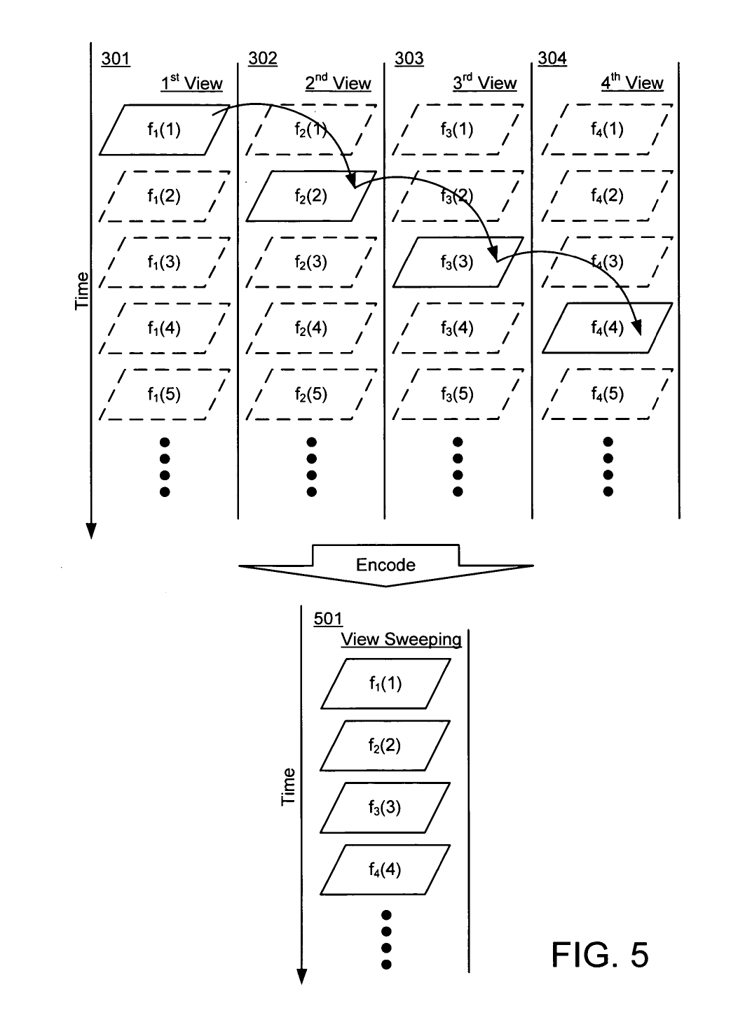

Multi-view video encoder 227 is configured to generate multi-view video streams. Particularly, the multi-view video streams are generated from frames in single-view video streams that are provided by capturing devices 111-116. Frames in the single-view video streams are selected based on the type of visual effects that are to be included in the multi-view video streams. Two example types of visual effects for multi-view video streams will be discussed in conjunction with FIG. 4 and 5. Video server 107 may receive single-view video streams that are encoded and compressed by control devices 123-125.

Multi-view video encoder 227 and its accompanying modules are configured to decode the single-view video streams to obtain frames that can be used to encode multi-view video streams. For example, if a selected frame from a single-view video stream is a predicted frame (P-frame) or a bi-direction frame (B-frame), multi-view video encoder 227 and its accompanying modules may be configured to obtain the full data of the frame and use the frame for encoding the multi-view video stream. Multi-view video encoder 227 may be configured to generate multi-view video streams in response to a request or continuously generate the streams and store them in a buffer for immediate access. In one implementation, a multi-view video stream is generated as a snapshot or a video clip, which includes a predetermined duration.

Client interaction handler 228 is configured to send and receive data to clients 153-156. Particularly, client interaction handler 228 provides video streams to clients 153-156 for viewing. Client interaction handler 228 may also be configured to receive selections from clients 153-156 related to video streams. For example, clients 153-156 may request to receive videos for a particular view direction. Client interaction handler 228 is configured to determine which single-view video stream to send based on the request. Clients 153-156 may also request to receive a multi-view video stream. In response, client interaction handler 228 may interact with multi-view video encoder 227 to generate the request multi-view video stream and provide the stream to the clients. Client interaction handler 228 may also provide the multi-view video stream from a buffer if the stream has already been generated and is available.

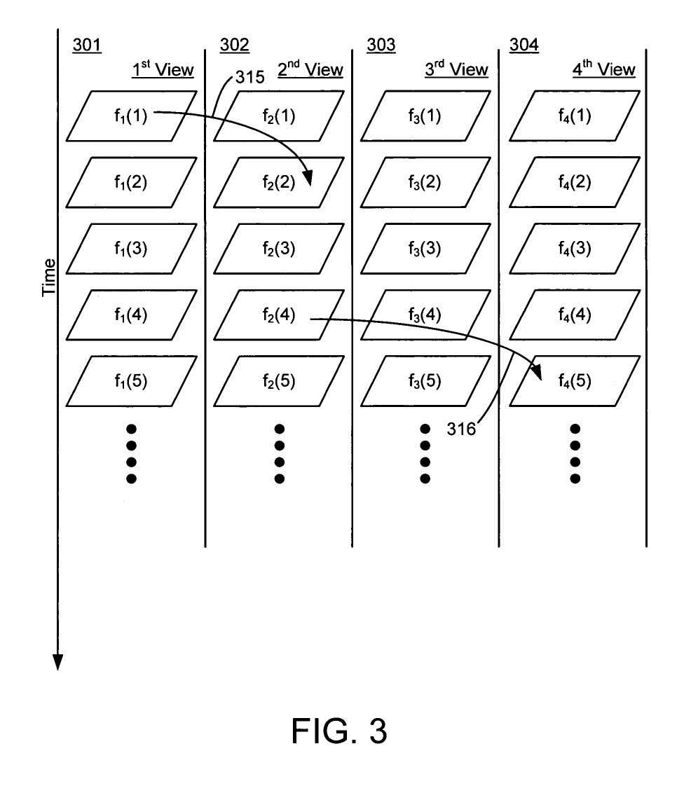

FIG. 3 shows example single-view video streams 301-304 generated by a video delivery system. Single-view streams 301-304 correspond to four different view direction. Each of the single-view streams 301-304 includes multiple frames, which are arranged as time synchronized in FIG. 3. Each of the frames is labeled as
fₙ(i)
where n represents the view direction and i represents the time index.

Single-view video streams 301-304 are typically provided by a video server to clients. Because of bandwidth restrictions, the video server may only be able to provide one single-view video stream to a client at a given time. The video server may enable the client to select which video stream to receive. For example, the client may be receiving single-view video stream 301 associated with the first view direction and may select to switch to the second view direction, as represented by indicator 315. In response, the video server may provide single-view video stream 302 to the client. Later, the client may select to switch to the fourth view direction, as represented by indicator 316, and video stream 304 may be provided to the client in response.

FIG. 4 shows an example of a multi-view video stream associated with a frozen moment effect. In a video stream with a frozen moment effect, time is frozen and the view direction rotates about a given point. For the example shown in FIG. 4, multi-view video stream 401 with frozen moment effect includes frames f₁(3), f₂(3), f₃(3), and f₄(3). Thus, a video server generates multi-view video stream 401 with frames from different single-view streams and corresponding to the same moment in time. As shown in FIG. 4, the frames are identified and encoded as a new video stream 401. The video server have to decode video streams 301-304 to obtain the full data for frames f₁(3), f₂(3), f₃(3), and f₄(3).

FIG. 5 shows an example of a multi-view video stream associated with a view sweeping effect. In a video stream with a view sweeping effect, the video sweeps through adjacent view directions while time is progressing. Thus, a video stream with view sweeping effect allows the viewing of a progressing event from different view directions. For the example shown in FIG. 5, multi-view video stream 501 includes frames f₁(1), f₂(2), f₃(3), and f₄(4). Thus, a video server generates multi-view video stream 401 with frames from different streams and corresponding to a progressing time index.

When providing the multi-view videos (such as the effects described above) to end users through communication channels, bandwidth limitation can become a challenging problem. A multi-view video clip includes a significant amount of data and the communication bandwidth may not be sufficient to deliver entire multi-view videos to end users. In an example implementation, a video server is used for organizing and delivering the multi-view video streams. On the server side, single-view video streams and multi-view video streams are prepared. Conventional single-view video stream, denoted by Vₙ(1<=n <=N), is represented by:
Vₙ={fₙ(1),fₙ(2),fₙ(3), . . . }
where fₙ(i) denotes the i^{th} frame of the n^{th} view direction. Each Vₙ may be independently compressed by a motion-compensated video encoder (i.e., in an IPPP format, where I stands for I-frame and P stands for P-frame).

Multi-view video streams may include video streams with visual effects, such as frozen moment stream F and view-sweeping stream S, which provide respectively the frozen moment effect and the view sweeping effect. Each stream may include many snapshots:
F ={F(1),F(2),F(3), . . . }
S ={S(1),S(2),S(3), . . . }
where each snapshot includes of N frames from different view directions:
F(i)={f₁(i), f₂(i), . . . ,f_{N}(i) }
S(i)={f₁(i),f₂(i+1), . . . ,f_{N}(i+N−1) }

Although the corresponding frames of F and S have already been compressed in Vₙ, the frames may not be available for use directly to form F(i) and S(i). For example, Vₙ may be encoded in a temporally predictive manner; thus decoding a certain P-frame requires dependent frames up to the recent I-frame. Also, even if all these frames are encoded as I-frames that do not depend on other frames, the compression efficiency may be very low. To address these problems, the video server may re-encoded the frames in the multi-view video stream.

Since frames of F(i) or S(i) may be captured from the same event but with different view directions, the frames are highly correlated. To exploit the view correlation, frames of the same snapshot are re-encoded. In one example implementation, the conventional motion-compensated video encoding is used. For example, the first frame, f₁(i), may be encoded as an I-frame, and the subsequent N-1 frames may be encoded as P-frames with the ith frame being predicted from the i−1th frame. This implementation may achieve a higher coding efficiency as the view correlation is utilized. Also, each snapshot may be decoded independently without knowledge of other snapshots, since each snapshot is encoded separately without prediction from other frames of different snapshots. This implementation can simplify snapshots processing and reduce the decoding latency. Furthermore, if a conventional compression algorithm is adopted for encoding the snapshots (e.g., the motion-compensated video compression algorithms such as MPEG), the decoder can treat the bitstream as a single video stream of the same format, no matter what kind of effect it provides. This is advantageous for compatibility with decoders in many end devices, such as the set-top box.

If the single-view videos are pre-captured, multi-view snapshots can be processed offline. On the other hand, if the single-view videos are captured in real-time, perhaps only some of the snapshots can be processed. This is because computation is required to re-encode snapshot F(i) and S(i), and it is difficult for the video server to process every snapshot due to its limited computing resources at the current stage. However, as the hardware performance increases, this limitation can be naturally removed. Moreover, it may be unnecessary to include every multi-view snapshot into stream F or S, since not all of the snapshots are interested by the users, especially for events with slow motion. Because of the above reasons, the snapshots may be sub-sampled. In an example implementation, a snapshot may be generated in a predetermined interval, such as every 1 5 frames. Thus, the practical sub-sampled F or S are:
F ={ . . . , F(i−15),F(i),F(i+15), . . . }
S ={ . . . , S(i−15),S(i),S(i+15), . . . }

After organizing the streams, streams Vn, F, and S may be used for interactive delivery. In one example, the video server may buffer the sub-sampled F and S for a certain amount of time in order to compensate for network latency. When a certain user subscribes to the video server, multi-view video service may be provided. Usually, the user will first see a default view direction, which may be the most attractive one among the N view directions. The user can then switch to other view directions, or enjoy the frozen moment effect or view sweeping effect by controlling the client player.

If a view switching command is received, the server may continue sending video stream of the current view direction until reaching the next L-frame of the new view direction. After that, the video server may send video stream of the new view direction starting from that I-frame. If a frozen moment or view sweeping command is received, the server may determine the appropriate snapshot F(i) or S(i) from the buffered F or S stream. For example, the appropriate snapshot may be the one with a time stamp that is close to the command's creation time. The determined snapshot may be sent immediately. After sending the snapshot, the server may send the video stream of the current view direction as usual.

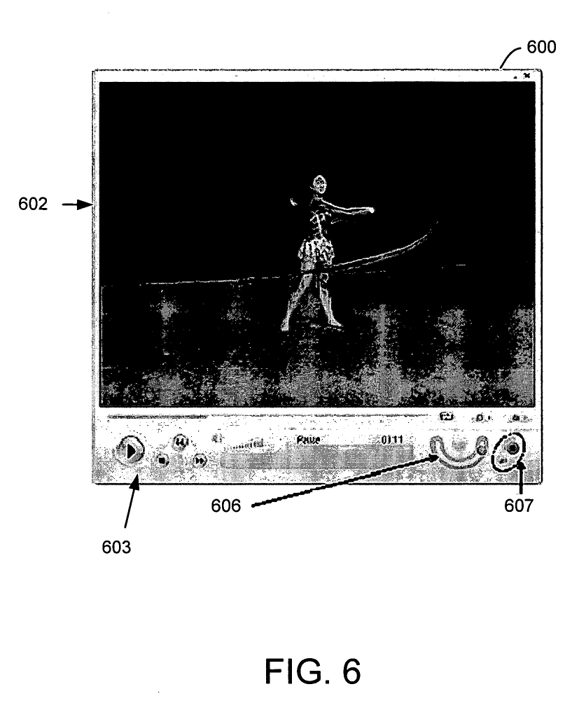

FIG. 6 shows an example user interface 600 for viewing multi-view videos. User interface 600 may be provided by an application on a client and that interacts with a video server. As shown in FIG. 6, user interface 600 includes a display area 602 for showing video streams provided by the video server. User interface 600 also includes control triggers 603 for controlling the playing of the video stream. View direction selector 606 enables the user to choose the view direction of the video. Particular, the application is configured to request and display the video stream that corresponds to the selected view direction. Effects selector 607 enables the user to select to receive multi-view videos. The application is configured to request and display the video stream that corresponds to the selected effect, such as frozen moment effect and view sweeping effect.

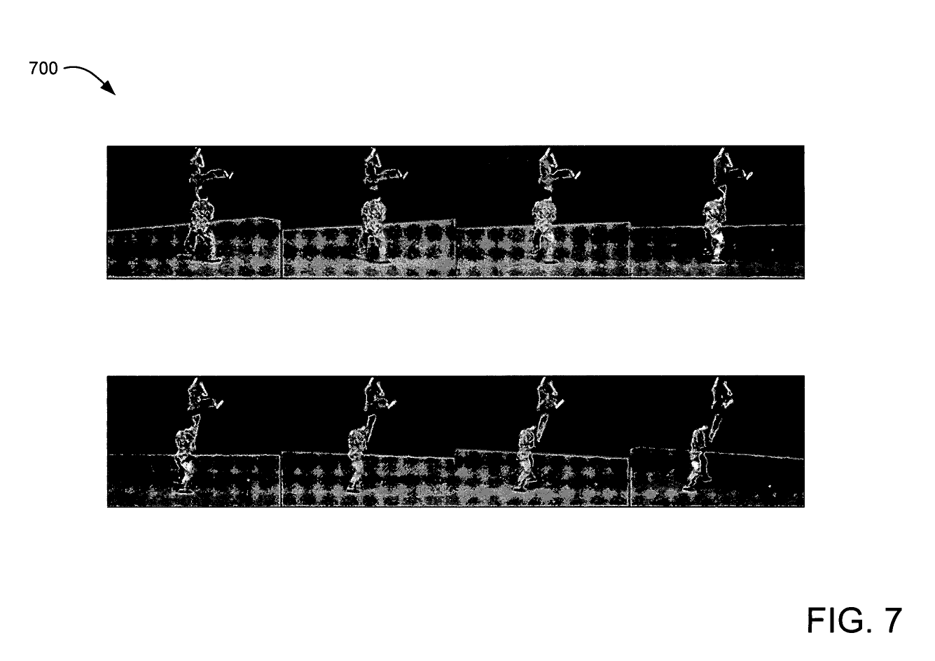

FIG. 7 shows frames 700 of an example frozen moment multi-view video stream. As shown in FIG. 7, the frames are associated with a particular moment in time and include images from different view directions.

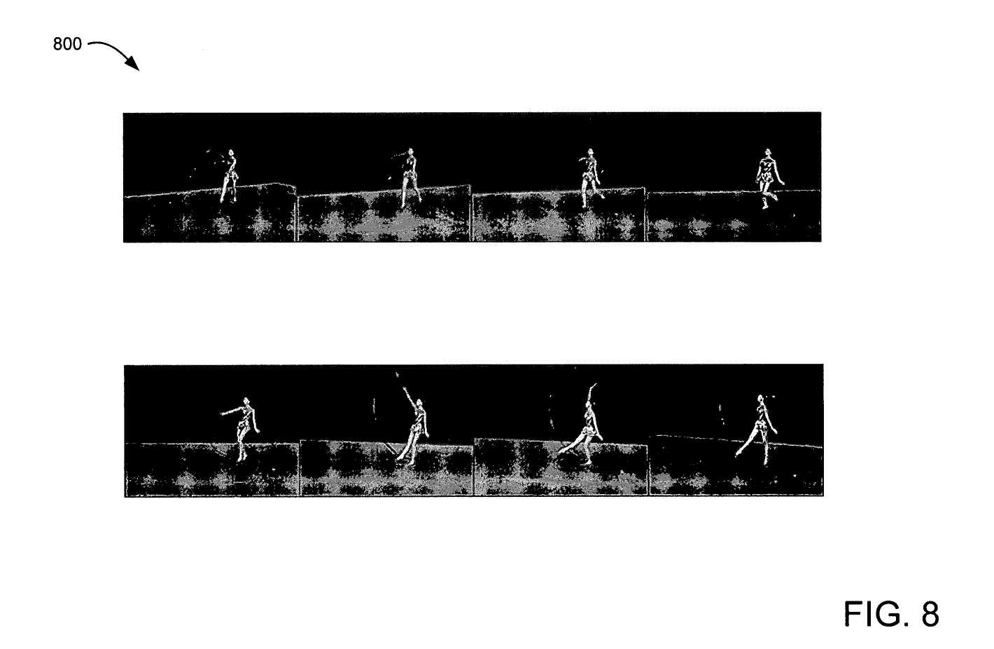

FIG. 8 shows frames 800 of an example view sweeping multi-view video stream. As shown in FIG. 8, the frames include images from different view directions and are corresponding to different, progressing moments in time.

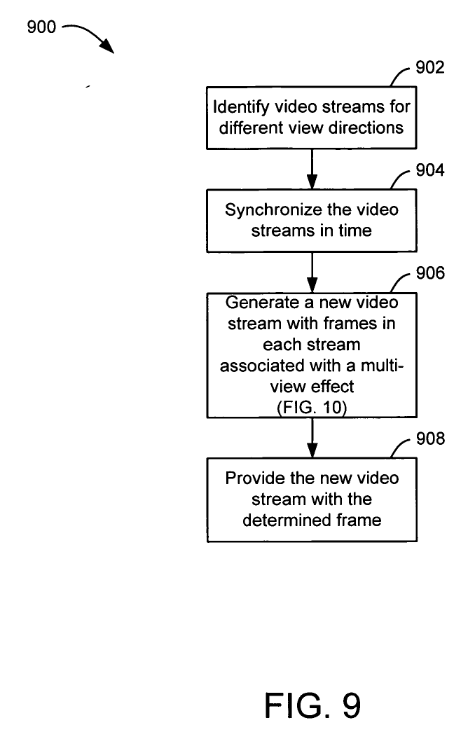

FIG. 9 shows an example process 900 for delivering multi-view video streams. Process 900 may be implemented by a video server to provide video streams with multi-view effects to a client. At block 902, single-view video streams for different view directions are identified. At block 904, the single-view video streams are synchronized in time. At block 906, a new video stream with frames associated with a multi-view effect is generated. The frames are selected from each of the single-view video streams. An example process for generating multi-view video streams will be discussed in conjunction with FIG. 9. At block 908, a new video stream with the selected frames is provided.

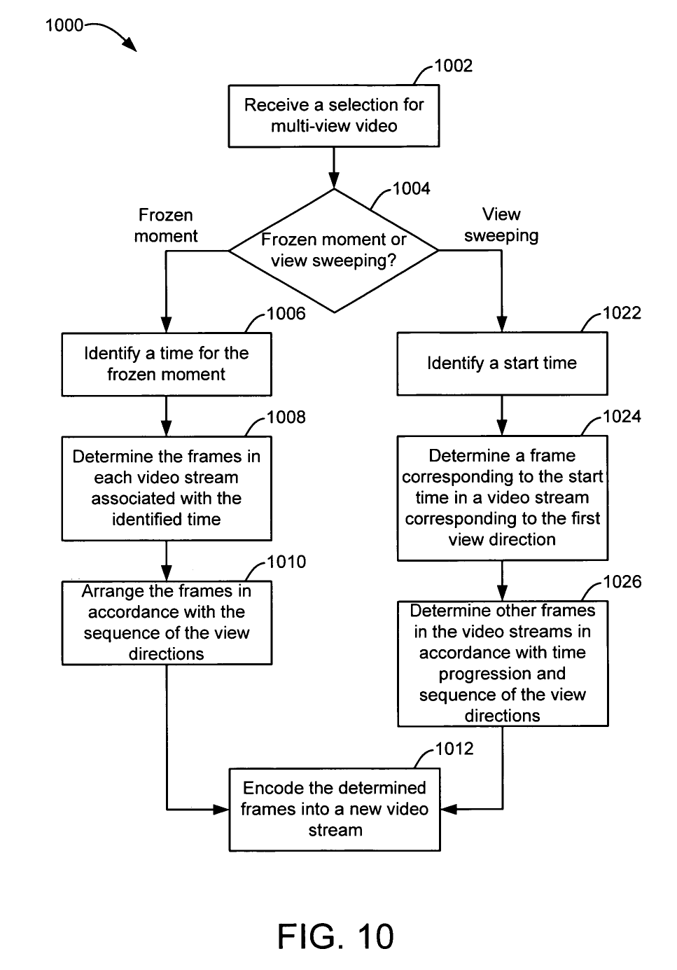

FIG. 10 shows an example process 1000 for generating a video stream with a multi-view effect. At block 1002, a selection for multi-view video is received. At decision block 1004, a determination is made whether a frozen moment effect or a view sweeping effect is selected. If a frozen moment effect is selected, process 1000 continues at block 1006 where a time for the frozen moment is identified. At block 1008, the frames in each video stream associated with the identified time are determined. At block 1010, the frames are arranged in accordance with the sequences of the view directions. The process then moves to block 1012.

Returning to decision block 1004, if a view sweeping effect is selected, process 1000 moves to block 1022 where a start time is identified. At block 1024, a frame corresponding to the start time in a video stream corresponding to the first view direction is determined. At block 1026, other frames in the video streams are determined in accordance with time progression and the sequence of the view directions. At block 1012, the determined frames are encoded in a new video stream.

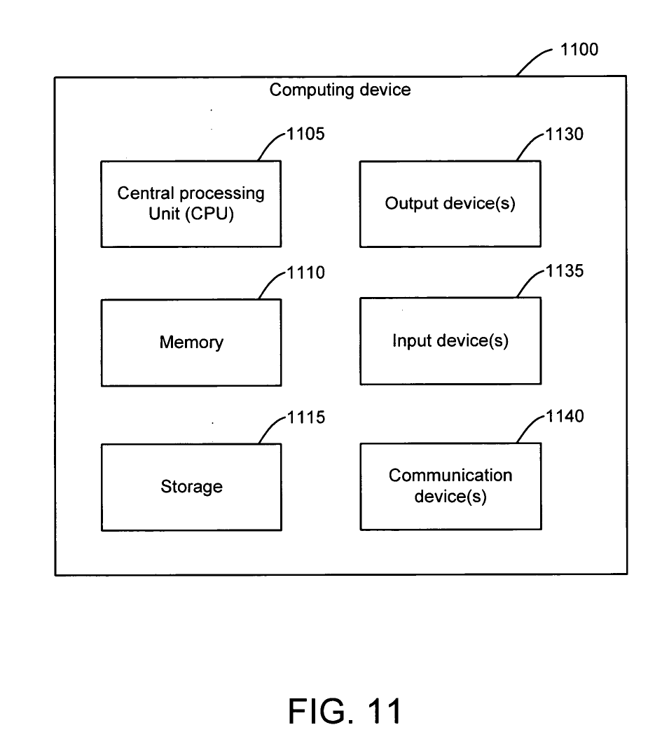

FIG. 11 shows an exemplary computer device 1100 for implementing the described systems and methods. In its most basic configuration, computing device 1100 typically includes at least one central processing unit (CPU) 1105 and memory 1110.

Depending on the exact configuration and type of computing device, memory 1110 may be volatile (such as RAM), non-volatile (such as ROM, flash memory, etc.) or some combination of the two. Additionally, computing device 1100 may also have additional features/functionality. For example, computing device 1100 may include multiple CPU's. The described methods may be executed in any manner by any processing unit in computing device 1100. For example, the described process may be executed by both multiple CPU's in parallel.

Computing device 1100 may also include additional storage (removable and/or non-removable) including, but not limited to, magnetic or optical disks or tape. Such additional storage is illustrated in FIG. 11 by storage 1115. Computer storage media includes volatile and nonvolatile, removable and non-removable media implemented in any method or technology for storage of information such as computer readable instructions, data structures, program modules or other data. Memory 1110 and storage 1115 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 1100. Any such computer storage media may be part of computing device 1100.

Computing device 1100 may also contain communications device(s) 1140 that allow the device to communicate with other devices. Communications device(s) 1140 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 1100 may also have input device(s) 1135 such as keyboard, mouse, pen, voice input device, touch input device, etc. Output device(s) 1130 such as a display, speakers, printer, etc. may also be included. All these devices are well know in the art and need not be discussed at length.

Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. One or more device-readable media encoded with device-executable instructions for performing steps comprising:
identifying video streams, each video stream associated with a different view direction;
determining frames associated with a multi-view effect in each of the identified video stream; and
generating a new video stream with the determined frames.

2. The one or more device-readable media as recited in claim 1, further comprising:
identifying a time associated with a frozen moment effect;
determining the frames in each of the identified video streams associated with the identified time;
arranging the frames in accordance with a sequence of the view directions associated with the identified video streams; and
encoding the arranged frames to generate the new video stream.

3. The one or more device-readable media as recited in claim 1, further comprising:
identifying a start time associated with a view sweeping effect;
determining a frame corresponding to the start time, the frame being in a video stream corresponding a first view direction;
determining other frames in the other identified video streams in accordance with time progression and a sequence of the view directions; and
encoding the determined frames to generate the new video stream.

4. The one or more device-readable media as recited in claim 1, wherein the multi-view video stream is generated as at least one of a snapshot or a video clip.

5. The one or more device-readable media as recited in claim 1, further comprising:
providing at least one of the identified video streams to a client;
in response to a request to receive a video with a multi-view effect,
providing the new video stream to the client instead of the at least one identified video stream, and
continuing to provide the at least one identified video stream when the new video stream has been provided to the client.

6. The one or more device-readable media as recited in claim 1, further comprising:
sub-sampling the new video stream to the client;
buffering the new video stream; and
providing the new video stream to the client in real-time.

7. The one or more device-readable media as recited in claim 1, further comprising:
decoding the identified video streams to obtain data associated with the determined frames; and
re-encoding the frames into the new video stream.

8. A system for providing video stream comprising:
capturing devices configured to generate video data, each capturing device associated with a particular view direction; and
a server configured to provide single-view video streams to clients, the single-view video streams including the video data generated by the capturing devices, the server also configured to identify frames associated with a multi-view effect in each single-view video stream and to encode the frames in a new video stream.

9. The system as recited in claim 8, wherein the server is further configured to provide the new video stream to at least one of the clients in response to a request to receive video with a multi-view effect and to continue to provide a single-view video stream to the at least one client after the new video stream with the multi-view effect has been sent.

10. The system as recited in claim 8, wherein the new video stream includes at least one of a frozen moment effect or a view sweeping effect.

11. The system as recited in claim 8, wherein the server is further configured to continuously generate and buffer the new video stream with the multi-view effect and to provide the new video stream from the buffer in real-time in response to a request from at least one of the client.

12. The system as recited in claim 8, wherein the new video stream is at least one of a snapshot or a video clip.

13. The system as recited in claim 8, further comprising control devices configured to interact with the capturing devices, each of the control devices also configured to handle video data generated by at least one of the capturing devices, the control devices further configured to encode the video data into the single-view video streams and to provide the single-view video streams to the server.

14. The system as recited in claim 13, wherein the control devices further configured to control an operating parameter that includes at least one of position, orientation, focus, aperture, frame rates, and resolution.

15. The system as recited in claim 8, wherein the control devices are further configured to specify a value for the operating parameter to the capturing devices in response to a request from the server.

16. An apparatus comprising:
means for obtaining single-view video streams, each single-view video stream corresponding to a different view direction;
means for generating a multi-view video stream from frames in the single-view video streams, the frames corresponding to a multi-view effect; and
means for interactively delivering at least one of the single-view video streams and the multi-view video stream in response to a request from a client.

17. The apparatus as recited in claim 16, further comprising:
means for sub-sampling the multi-view video stream; and
means for delivering the single-view video streams and the multi-view video stream to the client in real-time based on a selection from the client.

18. The apparatus as recited in claim 16, further comprising means for re-encoding the frames into the multi-view video stream.

19. The apparatus as recited in claim 16, further comprising means for selecting the frames from the single-view video streams for a frozen moment effect.

20. The apparatus as recited in claim 16, further comprising means for selecting the frames from the single-view video streams for a view sweeping effect.
